(19) United States
(12) Patent Application Publication
(10) Pub. No.: US 2006/0091819 A1
(43) Pub. Date: May 4, 2006

(54) Discharge lamp drive device and liquid crystal display device

(75) Inventors: Ge Li, Tokyo (JP); Masahiro Gamou, Tokyo (JP); Hiroshi Maeda, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: TDK Corporation, Tokyo (JP)

(21) Appl. No.: 11/203,958

(22) Filed: Aug. 16, 2005

(30) Foreign Application Priority Data
Oct. 29, 2004 (JP) 2004-316710

(51) Int. Cl. H05B 39/04

(52) U.S. Cl. 315/209 R

(57) ABSTRACT

The present invention is directed to a discharge lamp drive device and a liquid crystal display device, capable of keeping a tube current balance among discharge lamps to thereby prolong life durations of the discharge lamps. A drive circuit 311 outputs an AC voltage. Ballast circuits 312, 322 include “n” pieces of ballast capacitors C11 through C1n and C21 through C2n, respectively. The ballast capacitors C11 through C1n and C21 through C2n have one ends commonly connected to one another and directed to drive circuits 311 respectively, and other ends individually connected to discharge lamp connection terminals, respectively. Connected in parallel to at least two of ballast capacitors C11, C21, and C1n, C2n, are tube current compensation capacitors Cb3 and Cb1 thereby increasing capacitances of the ballast capacitors, respectively.

### BACKGROUND OF THE INVENTION

1. Field of the Invention

The present invention relates to a discharge lamp drive device and a liquid crystal display device. More specifically, the present invention relates to an improvement in a circuit for driving a discharge lamp constituting a backlight of a liquid crystal display device.

2. Description of the Related Art

Liquid crystal display devices are widely used as displays for notebook-sized personal computers and word processors, as liquid crystal monitors of personal computers, and as liquid crystal televisions.

Further increased sizes of recent liquid crystal panels lead to adoption of a scheme to arrange multiple discharge lamps (cold-cathode tubes) parallelly to one another with spacings therebetween in a relationship parallel to a surface of a frame, and to simultaneously turn on the discharge lamps, as disclosed in the patent literature 1 and the patent literature 2.

Incidentally, while application of voltages to discharge lamps result in leakage currents flowing through a frame due to parasitic capacitances produced between the discharge lamps and the frame, there are caused differences among leakage currents of the discharge lamps depending on an arranged situation of the discharge lamps within the frame, thereby breaking a tube current balance among the discharge lamps.

Since breakage of the tube current balance among the discharge lamps considerably affects life durations of the discharge lamps, it is necessary to avoid such breakage. However, there have not been known any conventional techniques capable of dealing with such a necessity, including the patent literature 1 (JP-A-2004-241136) and patent literature 2 (JP-A-1994-267674).

### SUMMARY OF THE INVENTION

It is therefore an object of the present invention to provide a discharge lamp drive device and a liquid crystal display device, capable of keeping a tube current balance among discharge lamps to thereby prolong life durations of the discharge lamps.

To achieve the object, the present invention provides a discharge lamp drive device comprising a drive circuit and a ballast circuit. The drive circuit comprises a circuit for outputting an AC voltage. The ballast circuit includes a plurality of capacitors, and the plurality of capacitors have one ends commonly connected to one another and directed to the drive circuit side, and other ends individually connected to plurally provided discharge lamp connection terminals. At least one of the plurality of capacitors has a capacitance larger than each of capacitances of the other capacitors.

The discharge lamp drive device according to the present invention is combined with discharge lamps, a backplate, and a liquid crystal panel, thereby constituting a liquid crystal display device. The backplate is formed of a metal material. The discharge lamp comprises a plurality of discharge lamps, which are arranged with spacings therebetween over one surface of the backplate, and which have electrodes connected to the discharge lamp connection terminals of the discharge lamp drive device, respectively. The liquid crystal panel is arranged in front of the discharge lamps.

In the liquid crystal display device having the above type of configuration, the discharge lamps are driven by an AC voltage to be supplied from the drive circuit through the ballast capacitors constituting the ballast circuit, so that tube currents are caused to flow through the discharge lamps to thereby turn them on.

Since the liquid crystal panel is arranged in front of the discharge lamps, displaying by liquid crystal is achieved while using the discharge lamps as backlights.

Further, the discharge lamps are arranged with spacings therebetween over the surface of the backplate which is made of the metal material and which is placed at a ground potential, thereby causing parasitic capacitances between the discharge lamps and the backplate.

The parasitic capacitances vary depending on distances between the discharge lamps and the backplate, respectively. Moreover, the distances between the discharge lamps and the backplate vary depending on an actual structure and shape of the backplate, and on arrangement relationships of the plurality of discharge lamps to the backplate, thereby making it impossible to achieve completely the same distances for all the discharge lamps.

Since the liquid crystal panel is required to be mounted in front of the discharge lamps in case of an actual backplate, the backplate includes raised portions provided at the peripheral sides of the backplate and raised from one surface of the backplate.

In a typical structure where the discharge lamps are arranged on the one surface of the backplate in such a relationship that the longitudinal directions of the discharge lamps become parallel to one peripheral side (of the above peripheral sides), the discharge lamps arranged closest to the raised portions cause parasitic capacitances between the associated raised portions in addition to parasitic capacitances to be produced between the surface of the backplate and the closest discharge lamps themselves, respectively.

As a result, without any countermeasures, the discharge lamps arranged closest to the associated raised portions cause larger leakage currents through the associated parasitic capacitances, than those of the discharge lamps arranged inside the closest discharge lamps in the above-mentioned example, thereby breaking a tube current balance among the discharge lamps to shorten life durations of the discharge lamps, respectively. Further, variance in brightness is caused among the discharge lamps.

Thus, in the liquid crystal display device according to the present invention, at least one of the plurality of capacitors included in the ballast circuit constituting the discharge lamp drive device, is configured to have a capacitance larger than each of capacitances of the other capacitors.

Further, the discharge lamp causing a larger leakage current is correspondingly connected to the discharge lamp connection terminal connected with the capacitor having the larger capacitance than each of capacitances of the other capacitors. This allows for a balanced tube current. The present invention will be more fully understood from the detailed description given here in below and the accompanying drawings which are given by way of illustration only, and thus are not to be considered as limiting the present invention.

### BRIEF DESCRIPTION OF THE DRAWINGS

FIG. 1 is a schematic view of a discharge lamp section of a liquid crystal display device incorporating therein a discharge lamp drive device according to an embodiment of the present invention;

FIG. 2 is a partially enlarged cross-sectional view of the liquid crystal display device shown in FIG. 1;

FIG. 3 is an enlarged view of the discharge lamp section in the liquid crystal display device shown in FIG. 1 and FIG. 2;

FIG. 4 is a graph of a relationship between a discharge lamp position and a parasitic capacitance in the arrangement shown in FIG. 3 where n=10;

FIG. 5 is an equivalent circuit diagram where one discharge lamp is driven; and

FIG. 6 is a schematic view of a liquid crystal display device according to another embodiment of the present invention.

### DESCRIPTION OF PREFERRED EMBODIMENTS

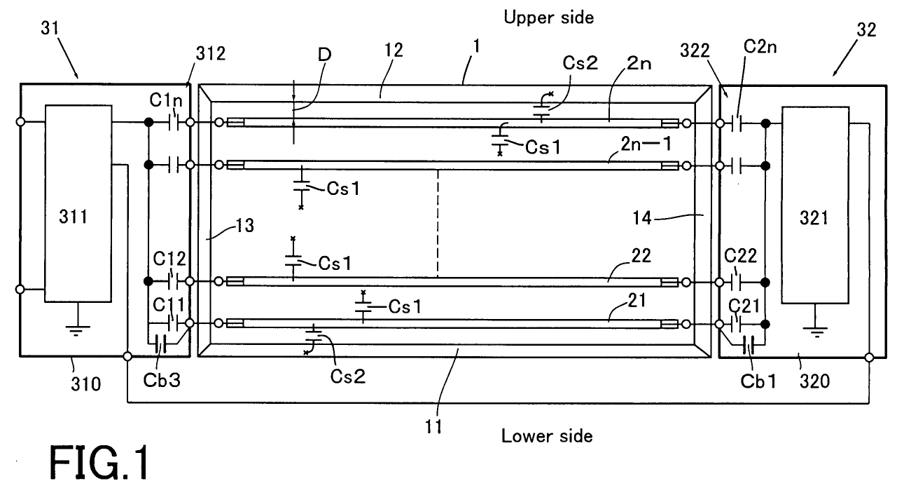

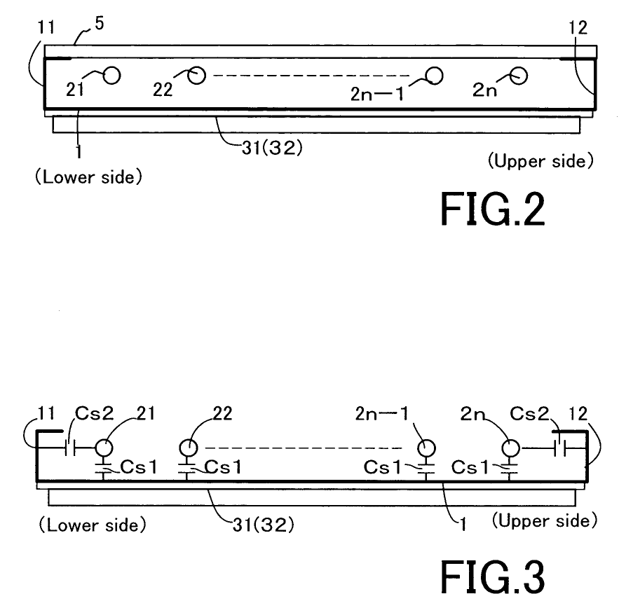

FIG. 1 is a schematic view of a discharge lamp section of a liquid crystal display device incorporating therein a discharge lamp drive device according to an embodiment of the present invention, and FIG. 2 is a partial cross-sectional view of the liquid crystal display device shown in FIG. 1. Omitted in FIG. 1 is a liquid crystal panel as an expediency for explanation. The illustrated embodiment exemplarily adopts a both-side drive style for driving discharge lamps from opposite ends thereof, for facilitated achievement of withstand voltage, for example. The present invention is of course applicable to a single-side drive style as well.

Referring to FIG. 1 and FIG. 2, the liquid crystal display device includes discharge lamp drive devices 31, 32, discharge lamps 21 through 2n, a backplate 1, and a liquid crystal panel 5. The discharge lamps 21 through 2n are cold cathode discharge lamps, respectively. In a cold cathode discharge lamp, application of current-voltage to each electrode leads to emission of electrons from the electrode, and the emitted electrons are accelerated within the tube and collide with molecules of inert gas (Ne—Ar gas), mercury, or the like. At that time, collided mercury molecules are brought into excited states and thereafter emit ultraviolet rays in the course of returning to ground states, where the ultraviolet rays are irradiated to a fluorescent substance coated on an inner surface of the tube so that the fluorescent substance generates visible light at various wavelengths. The brightness thereof has a proportional relationship to an electric current flowing through the discharge lamp.

The discharge lamp drive devices 31, 32 are configured with a combination of a first discharge lamp drive device 31 (hereinafter called “master unit”) and a second discharge lamp drive device 32 (hereinafter called “slave unit”). Since the illustrated liquid crystal display device has adopted the both-side drive style for driving the discharge lamps 21 through 2n from both sides thereof, respectively, the AC voltage to be applied to discharge lamp connection terminals by the slave unit 32 is to have a phase difference of 180° relative to the AC voltage to be applied to discharge lamp connection terminals of the master unit 31.

The master unit 31 is configured with a drive circuit 311, a first ballast circuit 312 and the like installed on a substrate 310. The drive circuit 311 is configured to generate an AC voltage based on a supply voltage Vin to be supplied from an outside. The supply voltage Vin is a stabilized DC voltage obtained by converting a commercial AC into DC and stabilizing it by a DC/DC converter or the like.

The drive circuit 311 includes a DC/AC converter, a transformer, a controlling circuit, and the like. The DC/AC converter typically comprises a switching type inverter, and is configured: to generate an AC voltage which is PWM controlled by the controlling circuit; and to output the AC voltage. The AC voltage prepared by the drive circuit 311 is supplied to the first ballast circuit 312 through the transformer.

The first ballast circuit 312 includes “n” pieces of ballast capacitors C11 through C1n. The ballast capacitors C11 through C1n have one ends commonly connected to one another and directed to the drive circuit 311 side, respectively, and other ends individually connected to plurally provided discharge lamp connection terminals, respectively. Although the ballast capacitors C11 through C1n basically have capacitances which are substantially the same, the capacitances may be slightly different from one another.

In the connection between the discharge lamps 21 through 2n and the master unit 31, the discharge lamp connection terminals, to which the other ends of the ballast capacitors C11 through C1n of the master unit 31 are connected, respectively, are individually connected with one electrodes of the discharge lamps 21 through 2n, respectively.

In turn, the slave unit 32 is configured with a drive circuit 321, a second ballast circuit 322, and the like installed on a substrate 320. The drive circuit 321 requires a transformer therein, but does not necessarily require a DC/AC converter, a controlling circuit or the like, unlike the master unit 31. This is because, the slave unit 32 is dependent on the master unit 31, and is allowed to share what are provided in the master unit 31. In the illustrated embodiment, the AC voltage to be outputted from the drive circuit 311 is supplied to the drive circuit 321 through a cable or the like.

The second ballast circuit 322 includes “n” pieces of ballast capacitors C21 through C2n. The ballast capacitors C21 through C2n have one ends commonly connected to one another and directed to the drive circuit 321 side, respectively, and other ends individually connected to the associated discharge lamp connection terminals, respectively. Although the ballast capacitors C21 through C2n basically have capacitances which are substantially the same, the capacitances may be slightly different from one another.

In the connection between the discharge lamps 21 through 2n and the slave unit 32, the discharge lamp connection terminals, to which the other ends of the ballast capacitors C21 through C2n of the slave unit 32 are connected, respectively, are individually connected with the other electrodes of the discharge lamps 21 through 2n, respectively.

The backplate 1 is formed of a metal material such as aluminum. Since the liquid crystal panel 5 is required to be mounted in front of the discharge lamps 21 through 2n, the backplate 1 includes raised portions 11 through 14 provided at the peripheral sides of the backplate 1 and raised from one surface of the backplate 1.

Arrangement of the discharge lamps 21 through 2n on the one surface of the backplate 1 results in occurrence of parasitic capacitances Cs1 between the discharge lamps 21 through 2n and the surface of the backplate 1, respectively (see FIG. 1 and FIG. 3). Since these parasitic capacitances Cs1 can be regarded as being substantially equal to one another among the discharge lamps 21 through 2n, such parasitic capacitances are insufficient to cause an unbalance among tube currents though leakage currents are caused. Rather, the problem resides in parasitic capacitances Cs2 caused between the two outermost discharge lamps 21, 2n and the backplate 1, respectively.

In an embodiment where the discharge lamps 21 through 2n are arranged in such a relationship that the longitudinal directions of the discharge lamps 21 through 2n become parallel to the raised portions 11, 12, the two outermost discharge lamps 21, 2n are located closer to the raised portions 11, 12, thereby causing parasitic capacitances Cs2 between the discharge lamps 21, 2n and the raised portions 11, 12, respectively, in addition to the accompanied parasitic capacitances Cs1. The parasitic capacitances Cs2 vary depending on distances D between the discharge lamps 21, 2n and the backplate 1, respectively.

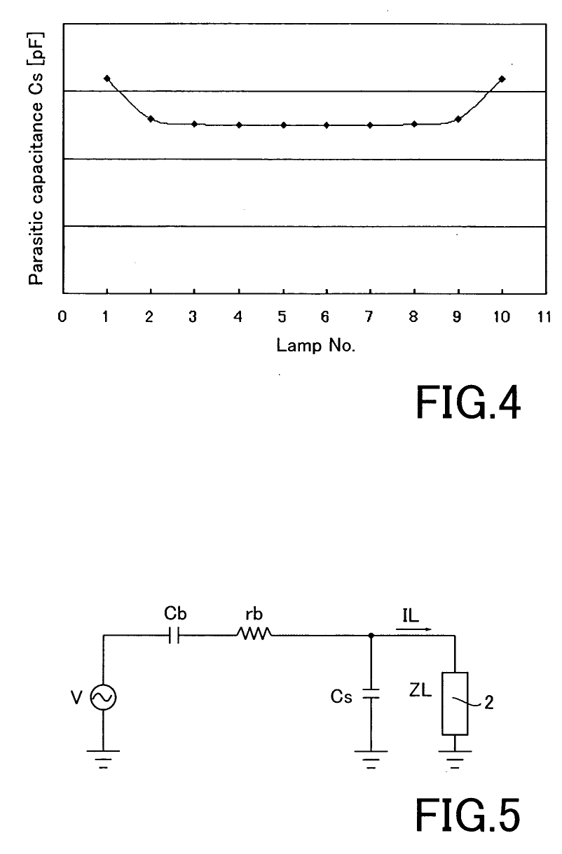

FIG. 4 is a graph of a relationship between a discharge lamp position and a parasitic capacitance in the arrangement shown in FIG. 3 where n=10. The discharge lamps numbered as “1” and “10” located closer to the raised portions 11, 12 exhibit larger parasitic capacitances, respectively.

Reconsidering the characteristic of FIG. 4 in the discharge lamp arrangement shown in FIGS. 1 through 3, the discharge lamps 21, 2n located closer to the raised portions 11, 12 exhibit leakage currents larger than those of the inwardly located discharge lamps 22 through 2n−1 to the extent of the parasitic capacitances Cs2, respectively, thereby breaking a tube current balance among the discharge lamps 21 through 2n to shorten life durations of the discharge lamps 21 through 2n, respectively. Another problem resides in deteriorated brightness of the discharge lamps 21, 2n.

As such, there are provided tube current compensation capacitors Cb1, Cb3 in parallel to the ballast capacitors C21, C11 connected to at least one (such as the discharge lamp 21) of the discharge lamps 21, 2n located closer to the raised portions 11, 12, respectively. This causes the discharge lamp 21 to have a sum of the capacitances of the ballast capacitors (C21+Cb1) and (C11+Cb3), meaning that the discharge lamp 21 has a capacitance larger than each of capacitances of the ballast capacitors (C12 through C1n−1, C22 through C2n−1) for the other discharge lamp connection terminals, respectively. This configuration allows for balanced tube currents among the discharge lamps 21 through 2n. This will be logically explained with reference to FIG. 5.

FIG. 5 is an equivalent circuit diagram where one discharge lamp is driven. When there is flowed a tube current IL through a discharge lamp 2 having an impedance Z by applying an AC voltage V thereto from an AC voltage source through a ballast capacitor Cb and an internal resistance rb of a ballast circuit, there is caused a parasitic capacitance Cs between the discharge lamp 2 and a ground. Further, the circuit has an impedance Z represented by the following equation (1):
Z=(1/jωCb)+rb+1/(jωCs+1/ZL) (1)

and, thus the tube current IL is represented by the following equation (2):
IL=V/Z (2).

According to the equation (1), the value of the ballast capacitor Cb is increased in case of the present invention including the tube current compensation capacitors Cb1, Cb3, so that the impedance Z is decreased to thereby increase the tube current IL according to the equation (2).

In the embodiment shown in FIGS. 1 through 3, the ballast capacitors for the discharge lamp 21 are increased in capacitance. This is based on a fact that, when the discharge lamps 21 through 2n are arranged one above the other while locating the discharge lamp 21 at the lowermost position, the lowermost discharge lamp 21 lacks a tube current balance as compared with the other discharge lamps 22 through 2n.

Although the uppermost discharge lamp 2n also causes the parasitic capacitance Cs2 between the discharge lamp 2n itself and the raised portions 11 and 12 as described above, the discharge lamp 2n is raised in temperature by radiant heats from the other discharge lamps when the discharge lamps are turned on to thereby exhibit an increased tube current through the discharge lamp 2n. Thus, the discharge lamp 2n is not so required to further increase its tube current, as compared with the lowermost discharge lamp 21. However, this does not reject provision for increasing a tube current of the uppermost discharge lamp 2n, as a matter of course.

Further, although the figures have shown the circuit where separate tube current compensation capacitors Cb1, Cb3 are connected in parallel to the ballast capacitors C21, C11, respectively, it is possible to adopt a configuration of tube current compensation capacitor comprising one or three or more capacitors insofar as the combined capacitance of the ballast capacitors C21, C11 and tube current compensation capacitors Cb1, Cb3 is ensured.

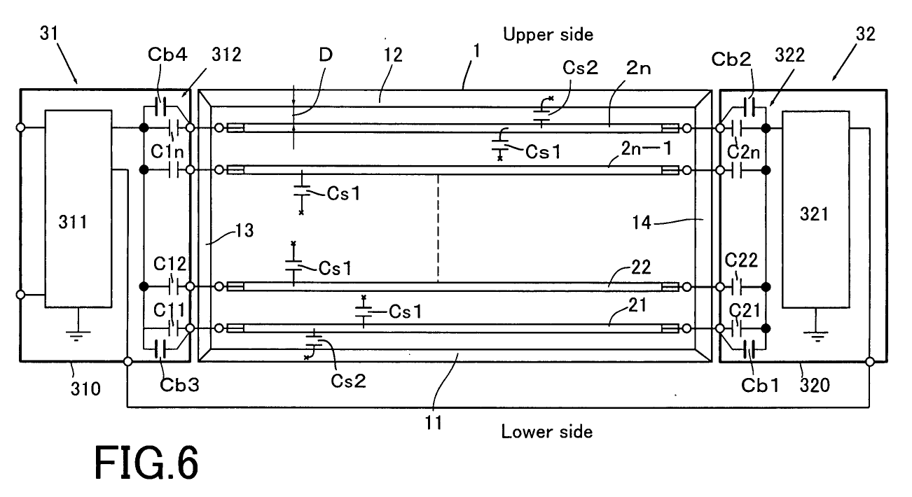

Next, there will be explained a liquid crystal display device according to another embodiment of the present invention with reference to FIG. 6. Like reference numerals as used in FIG. 1 are used to denote corresponding or identical constituent elements in FIG. 6 to avoid their otherwise redundant description. The liquid crystal display device shown in FIG. 6 includes tube current compensation capacitors Cb1, Cb2 connected in parallel to ballast capacitors C21 and C2n, respectively, and tube current compensation capacitors Cb3, Cb4 connected in parallel to ballast capacitors C11 and C1n, respectively, for a lowermost discharge lamp 21 and an uppermost discharge lamp 2n, respectively.

While the present invention has been particularly shown and described with reference to preferred embodiments thereof, it will be understood by those skilled in the art that various changes in form and detail may be made therein without departing from the spirit, scope and teaching of the invention.

What is claimed is:

1. A discharge lamp drive device comprising:
a drive circuit outputting an AC voltage; and
a ballast circuit including a plurality of capacitors, said capacitors having one ends commonly connected to one another and directed to said drive circuit, and other ends individually connected to a plurality of discharge lamp connection terminals, at least one of said capacitors having a capacitance larger than each of capacitances of the other capacitors.

2. The discharge lamp drive device according to claim 1, which further comprises a first discharge lamp drive device and a second discharge lamp drive device, and
wherein an AC voltage to be applied to said discharge lamp connection terminals of said second discharge lamp drive device has a phase difference of 180° relative to an AC voltage to be applied to said discharge lamp connection terminals of said first discharge lamp drive device.

3. A liquid crystal display device comprising:
a discharge lamp drive device recited in claim 1,
a backplate formed of a metal material;
discharge lamps arranged with spacings therebetween over one surface of said backplate and each having electrodes connected to said discharge lamp connection terminals of said discharge lamp drive device; and
a liquid crystal panel arranged in front of said discharge lamps.

4. A liquid crystal display device comprising:
a discharge lamp drive device recited in claim 2;
a backplate formed of a metal material;
discharge lamps arranged with spacings therebetween over one surface of said backplate, and
each having one electrode connected to said discharge lamp connection terminal of said first discharge lamp drive device and other electrode connected to said discharge lamp connection terminal of said second discharge lamp drive device; and
a liquid crystal panel arranged in front of said discharge lamps.

5. The liquid crystal display device according to claim 3 or 4, wherein said capacitor having the capacitance larger than each of capacitances of said other capacitors is connected to an outermost one of said discharge lamps.
